(19) United States
(12) Patent Application Publication
(10) Pub. No.: US 2022/0017391 A1
(43) Pub. Date: Jan. 20, 2022

(54) METHOD FOR TREATING SUSPENSIONS OF SOLID PARTICLES IN WATER USING AMPHOTERIC POLYMERS

(71) Applicant: S.P.C.M. SA, ANDREZIEUX -BOUTHEON (FR)

(72) Inventors: Morgan TIZZOTTI, ANDREZIEUX BOUTHEON (FR); Emmanuelle READ, ANDREZIEUX BOUTHEON (FR); Cédrick FAVERO, ANDREZIEUX BOUTHEON (FR); Nicolas GAILLARD, ANDREZIEUX BOUTHEON (FR)

(21) Appl. No.: 17/311,811

(22) PCT Filed: Dec. 18, 2019
(86) PCT No.: PCT/EP2019/086070

§ 371 Date: Jun. 8, 2021

(30) Foreign Application Priority Data
Dec. 20, 2018 (FR) FR1873519

(51) Int. Cl. C02F 1/56; C08F 220/56; C02F 1/52

(52) U.S. Cl. CPC C02F 1/56; C08F 220/56; C02F 2103/10; C08F 2800/10; C08F 2810/50; C02F 1/5272

(57) ABSTRACT

The present invention relates to an effluent treatment method for treating an aqueous effluent having solid particles, the method including the addition to the effluent of at least one water-soluble polymer comprising at least one non-ionic monomer and at least one anionic monomer obtained by controlled radical polymerization, the said polymer having a UL viscosity of between 2 and 4.5 cps.

The invention relates to an effluent treatment method for treating a suspension of solid particles in water, such as mineral tailings (residues). This method includes the contacting step of bringing the suspension of solid particles in water into contact with a specific, water-soluble polymer.

The invention relates to the treatment of mining tailings (residues) in the form of aqueous effluents containing solid particles. The method of the invention makes it possible to separate all or part of the water from an aqueous effluent that contains solid particles. This method includes the addition to the effluent of at least one water-soluble polymer obtained by controlled radical polymerization.

The invention also relates to a composition comprising an aqueous effluent that contains the treated solid particles, and the water-soluble polymer obtained by controlled radical polymerization. Preferably, it relates to a composition comprising an aqueous effluent that contains solid particles, and at least one water-soluble polymer obtained by controlled radical polymerization.

A number of mining industry extraction methods produce tailings in the form of aqueous effluents that contain solid particles. For example, the production of hydrocarbons from oil sands, or bituminous or tar sands, leads to generation of such mining tailings. The management of mining tailings therefore constitutes a major challenge for the mining industry, most notably since the inception of oil sands development and operation. It is thus incumbent upon the operators to determine the most appropriate manner for disposing of these by-products safely and efficiently. The challenge is made all the more significant by the size of the oil sands.

In a general manner, mining operations also generate such tailings or waste materials, in particular during the extraction of ores for the production of coal, diamonds, phosphate or various different metals, for example aluminum, platinum, iron, gold, copper, silver, etc. Such tailings may also result from the processing of ores or indeed from industrial or washing processes.

The mining industry tailings may take various different forms, such as sludge in particular. In general, these are suspensions of solid particles in water.

Generally, oil sands tailings therefore consist of water, clay, sand, and residual hydrocarbons deriving from the extraction process.

Historical and current practices in the industry have consisted of pumping tailings into vast settling ponds (tailings ponds). Subsequently, the heaviest material, mainly sand, settles to the bottom, while the water rises to the surface and can be recycled. The intermediate layer, known as mature fine tailings (MFT), is generally composed of 70% by weight of water and 30% by weight of fine clay particles. Naturally, the layer of mature fine tailings could take centuries to solidify. The continued development of mining operations has necessitated the creation of a growing number of settling ponds that are ever increasing in size.

Thus, the mineral sludge or slurry produced by the physical or chemical treatment processes of the bituminous or tar sands are stored in open pools or basins, ponds, retention dams (tailings dams) or embankments in semi-liquid form. These large volumes of stored sludge therefore pose a real hazard, in particular in the event of failure of the dykes.

In particular due to technical, environmental or regulatory imperatives, it has now become necessary to find a way to accelerate or improve efficiency with respect to the transformation of fine mature tailings into a stable firm deposit that can then be reclaimed and rehabilitated.

Land remediation and rehabilitation following mining development has been made mandatory by environmental legislation.

Acceleration of the treatment and processing of mine tailings is also necessary, in particular by increasing the rate of sedimentation of tailings in order to recycle water efficiently as well as to reduce the volume of tailings.

In a general manner, the separation and recycling of all or part of the water present within aqueous mining effluents are considered essential goals during mining operations. Thus, the processes for treating aqueous effluents that comprise solid particles serve the essential objective of improving the water separation efficiency and yield, in particular with a view to recycling the separated water as well as enabling easy handling of the final tailings. The increase in this net water separation efficiency (ie, Net Water Release or NWR) constitutes an important objective of the methods and processes for treating aqueous effluents that comprise solid particles.

Various treatment methods for the physical treatment of these mining tailings are known, for example centrifugation, filtration, electrophoresis and electrocoagulation.

On the other hand, new chemical processes continue to emerge. For example, known processes include those involving the addition of chemicals such as sodium silicate, organic flocculating agents, inorganic coagulating agents, oxidizing agents, reducing agents, or even carbon dioxide. Also a known practice is the use of synthetic polymers as coagulation or flocculation agents, in order to separate the solids from the liquid.

However, these techniques do not serve to provide an entirely effective solution to the problems encountered, in particular from a technical, environmental, or public interest point of view.

In addition, the polymers currently used have a dosage limit beyond which the relevant performance elements no longer undergo enhancement, and indeed may even degrade.

It is therefore necessary to be able to avail of methods that provide the means to offer solutions to all or part of the problems encountered with the methods of the state of the art.

Thus, the invention provides an effluent treatment method for treating an aqueous effluent that contains solid particles, the method including the addition to the effluent of at least one water-soluble polymer obtained by controlled radical polymerization, the said polymer having a UL viscosity (viscosity in solution) of between 2 and 4.5 cps.

The invention also relates to an effluent treatment method for treating an aqueous effluent that contains solid particles, the method including the addition to the effluent of at least one water-soluble polymer comprising at least one non-ionic monomer and at least one anionic monomer obtained by controlled radical polymerization, the said polymer having a UL viscosity of between 2 and 4.5 cps.

The term “water-soluble polymer” is understood to refer to a polymer which, when caused to dissolve by means of agitation in water at a temperature of 25° C. at a concentration of 50 g/l, provides a solution free of insoluble particles.

Controlled radical polymerization (CRP) techniques include such techniques as polymerization by transfer of iodine (Iodine Transfer Polymerization—ITP), polymerization controlled by nitroxides (Nitroxide Mediated Polymerisation—NMP), polymerization by atom transfer (Atom Transfer Radical Polymerization—ATRP), by reversible addition-fragmentation chain transfer (Reversible Addition Fragmentation Chain Transfer Polymerization—RAFT), which includes the technology MADIX (MAcromolecular Design by Interchange of Xanthates), different variations of polymerizations with organometallic compounds (Organometallic Mediated Radical Polymerization—OMRP), radical polymerization controlled by heteroatomic compounds (OrganoHeteroatom-mediated Radical Polymerization—OHRP).

In a preferential manner, the controlled radical polymerization is a polymerization by reversible addition-fragmentation chain transfer, RAFT (Reversible Addition Fragmentation Chain Transfer Polymerization).

All of these techniques are based on a reversible equilibrium being established between a dormant species and an active species (growing macro-radical), as illustrated in FIG. 10.

This activation-deactivation process allows for the chains to grow at the same speed (rate), until the monomer is totally consumed, thus making it possible to control the molecular weights of the polymers and thereby obtain narrow distributions of molecular weights. This will also make it possible to minimize the heterogeneity of the composition. The reversible deactivation of growing chains can be attributed with the minimizing of irreversible termination reactions. The vast majority of polymer chains remain in dormant form and are therefore reactivable. It is thus then possible to functionalize the chain ends in order to initiate other modes of polymerization or to make chain extensions. This is the key to accessing high molecular weights, controlled architectures and compositions.

The controlled radical polymerization therefore presents the following distinctive aspects:

1. The number of polymer chains is fixed throughout the entire duration of the reaction;

2. The polymer chains all grow at the same speed, which results in:
A linear increase in molecular weights;
A narrow distribution of molecular weights;

3. The average molecular weight is controlled by the monomer/precursor molar ratio.

The controlled nature is all the more marked since the rate of reactivation of the radical chains is very high as compared to the rate of chain growth (propagation). However, in certain cases, the rate of reactivation of the radical chains is lower than or equal to the rate of propagation. In these cases, the conditions 1 and 2 above are not observed and, consequently, the control of molecular weights is not possible.

In a preferential manner, the controlled radical polymerization is carried out with a control agent having the formula (I):

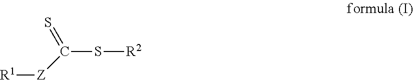

in which
Z═O, S or N;
R¹ and R², being identical or different, represent:
a group (i): alkyl, acyl, alkenyl or alkynyl, optionally substituted; or
a carbon ring (ii), either saturated or unsaturated, optionally substituted or aromatic; or
a heterocycle (iii), either saturated or unsaturated, optionally substituted or aromatic;

it being possible for these groups and rings (i), (ii), and (iii) to be substituted by substituted aromatic groups; or the groups: alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl; groups that are hydrophilic or ionic in nature such as the alkali salts of carboxylic acids, the alkali salts of sulfonic acid, polyalkylene oxide chains (polyoxyethylene POE, polyoxypropylene POP), cationic substituents (quaternary ammonium salts),

R representing an alkyl or aryl group.

In a more preferential manner, the controlled radical polymerization is carried out with a control agent having the formula (I):

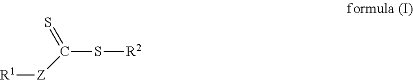

in which
Z═O, S or N;
R¹ and R², being identical or different, represent:
a group (i): linear or branched alkyl comprising from 1 to 20 carbons, preferably from 1 to 10 carbons, optionally substituted; linear or branched acyl comprising from 1 to 20 carbons, preferably from 1 to 10 carbons, optionally substituted; linear or branched alkenyl comprising from 2 to 20 carbons, preferably from 2 to 10 carbons, optionally substituted; or linear or branched alkynyl comprising from 2 to 20 carbons, preferably from 2 to 10 carbons, optionally substituted; or
a carbon ring (ii), either saturated or unsaturated, optionally substituted or aromatic, comprising from 4 to 7 carbons, preferentially from 5 to 6 carbons; or
a heterocycle (iii), either saturated or unsaturated, optionally substituted or aromatic, comprising 1, 2 or 3 heteroatoms selected from O, N or S, and from 3 to 6 carbons, preferentially from 4 to 5 carbons;

it being possible for these groups and rings (i), (ii), and (iii) to be substituted by substituted aromatic groups; or the groups: alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl; groups that are hydrophilic or ionic in nature such as the alkali salts of carboxylic acids, the alkali salts of sulfonic acid, polyalkylene oxide chains (polyoxyethylene POE, polyoxypropylene POP), cationic substituents (quaternary ammonium salts);

R representing a linear or branched alkyl group comprising from 1 to 20 carbons, preferably from 1 to 10 carbons, or aryl comprising from 6 to 10 carbon atoms.

According to one preferred embodiment, the control agent has the formula (I) in which:
Z═O.

According to another preferred embodiment, the control agent has the formula (I) in which:
Z═O.
   R¹ and R², being identical or different, represent a group (i): linear or branched comprising from 1 to 20 carbons, preferably from 1 to 10 carbons; linear or branched acyl comprising from 1 to 20 carbons, preferably from 1 to 10 carbons; linear or branched alkenyl comprising from 2 to 20 carbons, preferably from 2 to 10 carbons; or linear or branched alkynyl comprising from 2 to 20 carbons, preferably from 2 to 10 carbons; these groups being optionally substituted by one or more substituted aromatic groups comprising from 4 to 7 carbons; or the groups: alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl; groups that are hydrophilic or ionic in nature such as the alkali salts of carboxylic acids, the alkali salts of sulfonic acid, polyalkylene oxide chains (polyoxyethylene POE, polyoxypropylene POP), cationic substituents (quaternary ammonium salts);

R representing a group: linear or branched alkyl comprising from 1 to 20 carbons, preferably from 1 to 10 carbons; or aryl comprising from 6 to 10 carbon atoms.

According to one other preferred embodiment, the control agent has the following formula (II):

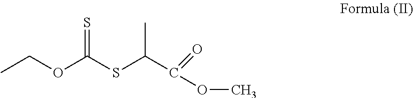

The water-soluble polymer obtained by controlled radical polymerisation is prepared from at least one non-ionic monomer, and/or at least one anionic monomer, and/or at least one cationic monomer.

The one or more non-ionic monomer(s) which it is possible to use within the framework of the invention may be selected, in particular, from the group comprising vinyl monomers that are water soluble. The preferred monomers belonging to this class are, for example, acrylamide, methacrylamide; N-isopropylacrylamide; N,N-dimethylacrylamide; N,N diethylacrylamide; N-methylolacrylamide; N-vinylformamide; N-vinyl acetamide; N-vinylpyridine; N-vinylpyrrolidone; acryloyl morpholine (ACMO), glycidyl methacrylate, glyceryl methacrylate, and diacetone acrylamide. A preferred non-ionic monomer is acrylamide.

The one or more non-ionic monomer(s) are preferably used in an amount ranging from 50 to 90 mol %, more preferentially from 30 to 45 mol %, relative to the total number of moles of monomers. In a particularly preferred manner according to the invention, the water-soluble polymer is a polymer prepared from acrylamide.

The one or more anionic monomer(s) are preferentially selected from among acrylic acid; methacrylic acid; itaconic acid; crotonic acid; maleic acid; fumaric acid; 2-acrylamido-2-methylpropane sulfonic acid; vinyl sulfonic acid; vinylphosphonic acid; allylsulfonic acid; allylphosphonic acid; styrene sulfonic acid, the said anionic monomer being non-salified, partially or totally salified, and the salts of 3-sulfopropyl methacrylate. The salified form advantageously corresponds to the salts of alkali metals (Li, Na, K, etc), salts of alkaline earth metals (Ca, Mg, etc.), or salts of ammonium, in particular quaternary ammoniums.

The one or more anionic monomer(s) are preferably used in an amount ranging from 10 to 70 mol %, preferably ranging from 20 to 55 mol %, relative to the total number of moles of monomers.

The particularly preferred anionic monomers are acrylic acid, 2-acrylamido-2-methylpropanesulfonic acid and the corresponding salts thereof.

The one or more cationic monomer(s) which it is possible to use within the framework of the invention may be selected, in particular, from among the monomers of such types as acrylamide, acrylic, vinyl, allyl or maleic, having a quaternary ammonium functional group by salification or quaternisation. Mention may be made, in particular and without any limitation whatsoever, of quaternised dimethylaminoethyl acrylate (DMAEA), quaternised dimethylaminoethyl methacrylate (DMAEMA), diallyldimethylammonium chloride (DADMAC), acrylamido propyltrimethyl ammonium chloride (APTAC), and methacrylamido propyltrimethyl ammonium chloride (MAPTAC), the said cationic monomer being non-salified, or partially or totally salified.

The one or more cationic monomer(s) are preferably used in an amount ranging from 0.01 to 10 mol %, preferably ranging from 0.1 to 4 mol %, relative to the total number of moles of monomers.

The monomer may optionally be a zwitterionic monomer of such types as acrylamide, acrylic, vinyl, allylic or maleic, having an amine or a quaternary ammonium functional group and an acid functional group of such types as carboxylic, sulfonic or phosphoric. Mention may be made, in particular and without any limitation whatsoever, of the derivatives of dimethylaminoethyl acrylate, such as 2-((2-(acryloyloxy) ethyl) dimethylammonio) ethane-1-sulfonate, 3-((2-(acryloyloxy) ethyl) dimethylammonio) propane-1-sulfonate, 4-((2-(acryloyloxy) ethyl) dimethylammonio) butane-1-sulfonate, [2-(acryloyloxy) ethyl)] (dimethylammonio) acetate; the derivatives of dimethylaminoethyl methacrylate such as 2-((2-(methacryloyloxy)ethyl)dimethylammonio)ethane-1-sulfonate, 3-((2-(methacryloyloxy) ethyl) dimethylammonio) propane-1-sulfonate, 4-((2-(methacryloyloxy) ethyl) dimethylammonio) butane-1-sulfonate, [2-(methacryloyloxy) ethyl)] (dimethylammonio) acetate; the derivatives of dimethylamino propylacrylamide such as 2-((3-acrylamidopropyl) dimethylammonio) ethane-1-sulfonate, 3-((3-acrylamidopropyl) dimethylammonio) propane-1-sulfonate, 4-((3-acrylamidopropyl)dimethylammonio)butane-1-sulfonate, [3-(acryloyloxy) propyl)] (dimethylammonio) acetate; the derivatives of dimethylamino propyl methylacrylamide such as 2-((3-methacrylamidopropyl) dimethylammonio) ethane-1-sulfonate, 3-((3-methacrylamidopropyl) dimethylammonio) propane-1-sulfonate, 4-((3-methacrylamidopropyl) dimethylammonio) butane-1-sulfonate, and [3-(methacryloyloxy)propyl)](dimethylammonio)acetate.

Preferentially, the water-soluble polymer obtained by controlled radical polymerization is obtained from at least one non-ionic monomer and at least one anionic monomer.

Preferentially, the water-soluble polymer obtained by controlled radical polymerization is obtained from acrylamide and acrylic acid.

In an advantageous manner, the water-soluble polymer obtained by controlled radical polymerization exclusively comprises water-soluble monomers. The term “water-soluble monomers” is understood to refer to all of the monomers having a solubility in water that is greater than 100 g/l, preferentially greater than 200 g/l, at 25° C.

The radical polymerization initiator may be selected from among the initiators conventionally used in radical polymerization. It may for example be one of the following initiators:
hydrogen peroxides such as those selected from the group comprising tertiary butyl hydroperoxide, cumene hydroperoxide, t-butyl-peroxyacetate, t-butyl peroxybenzoate, t-butyl peroxyoctoate, t-butyl peroxyneodecanoate, t-butyl peroxyisobutarate, lauroyl peroxide, t-amyl peroxypivalte, t-butylperoxypivalate, dicumyl peroxide, benzoyl peroxide, potassium persulfate, and ammonium persulfate;
azo compounds such as those selected from the group comprising 2-2′-azobis (isobutyronitrile), 2,2′-azobis (2-butanenitrile), 4,4′-azobis (4-pentanoic acid), 1,1′-azobis (cyclohexane-carbonitrile), 2-(t-butylazo)-2-cyanopropane, 2,2′-azobis [2-methyl-N-(1,1)-bis (hydroxymethyl)-2-hydroxyethyl] propionamide, 2,2′-azobis [2-methyl-N-hydroxyethyl]-propionamide, 2,2′-azobis (N,N′-dimethyleneisobutyramidine) dichloride, 2,2′-azobis (2-amidinopropane) dichloride, 2,2′-azobis (N,N′-dimethyleneisobutyramide), 2,2′-azobis (2-methyl-N-[1,1-bis (hydroxymethyl)-2-hydroxyethyl] propionamide), 2,2′-azobis (2-methyl-N-[1,1-bis (hydroxymethyl) ethyl] propionamide), 2,2′-azobis(2-methyl-N-(2-hydroxyethyl)propionamide], and 2,2′-azobis (isobutyramide)dihydrate;
redox systems including combinations such as those selected from the group comprising:
   mixtures of a) hydrogen peroxide or alkyl peroxide, peresters, or percarbonates and the like; and of b) any of the iron salts, titanous salts, zinc formaldehyde sulfoxylate or sodium formaldehyde sulfoxylate; and c) reducing sugars;
   persulfates, perborate or perchlorate of alkali metals or ammonium in combination with an alkali metal bisulfite, such as sodium metabisulfite, and reducing sugars; and
   alkali metal persulfates in combination with an arylphosphinic acid, such as benzene phosphonic acid and the like, and reducing sugars.

In a preferential manner, the said polymer has a UL viscosity of between 2.5 to 4.2 cps.

The UL viscosity is measured using a Brookfield Viscometer—type LVT, equipped with a UL adapter having a module that rotates at 60 revolutions/minute (0.1% of polymer by weight in a saline solution of sodium chloride 1 M at 25° C.).

The polydispersity index (Ip) of the polymer obtained according to the invention is advantageously at most 2 (2), preferably at most 1.5, (1.5). The polydispersity index is determined according to the following formula:

Ip=Mw/Mn

Mw is the weight average molecular weight

Mn is the number average molecular weight

The determination of the average molecular weights in terms of weight average (Mw) and number average (Mn), is carried out in a conventional manner, advantageously by means of steric exclusion chromatography (CES) coupled to a multi-angle light scattering detector—model type Dawn Heleos II, 18 angles (Wyatt Technology).

According to the invention, the effluent is advantageously a mining operation effluent, deriving from coal mines, diamond mines, phosphate mines, metal mines such as aluminum, platinum, iron, gold, copper, silver, etc. The effluent may also be an effluent from bituminous sands or oil sands mining operations.

Preferably, the effluent is an effluent from bituminous sands or oil sands mining operations. In addition to the solid particles, the effluent includes water. It may comprise sand, clay and water, or indeed sand, clay, water and residual bitumen.

Generally, the aqueous effluent according to the invention contains from 5 to 70% by mass, preferably from 20 to 50% by mass, more preferentially from 30 to 40% by mass, of solid particles, in particular mineral particles in particular selected from clay and sand or the mixtures thereof.

The effluent treated according to the method of the invention can comprise various different tailings. These tailings may be fresh tailings or fine tailings. Preferably, it is an effluent that comprises mature fine tailings (MFT or RFM for ‘résidus fins mûrs’), or an effluent that comprises fresh fine tailings (FFT or RFF for ‘résidus fins frais’); in particular it is an effluent that comprises mature fine tailings (MFT or RFM for ‘résidus fins mûrs’), and more particularly it is an effluent that comprises mature fine tailings (MFT or RFM for ‘résidus fins mûrs’′) containing an amount of clays ranging from 5 to 70% by mass.

In a general manner, the aqueous effluent resulting from oil sands mining operations and treated according to the invention, may also comprise residual bitumen. The residual bitumen is thus then present in small amounts, generally in an amount less than 5% by mass of aqueous effluent.

The invention also relates to the use for treating an aqueous effluent that contains solid particles, of at least one polymer obtained by controlled radical polymerization, the said polymer having a UL viscosity of between 2 and 4.5 cps.

The invention also relates to a composition comprising an aqueous effluent that contains solid particles, at least one polymer obtained by controlled radical polymerization, the said polymer having a UL viscosity of between 2 and 4.5 cps.

### LIST OF FIGURES

FIG. 1 represents the NWR (Net Water Release) according to the dosage of the counterexample and the CRP polymers

FIG. 2 represents the NWR according to the dosage of the counterexample and of the CRP polymer 1

FIG. 3 represents the NWR according to the dosage of the counterexample and of the CRP polymers

FIG. 4 represents the NWR according to the dosage of the polymers A and A′

FIG. 5 represents the NWR according to the dosage of the polymers B and B′

FIG. 6 represents the NWR according to the dosage of the polymers C and C′

FIG. 7 represents the NWR according to the dosage of the polymers D and D′

FIG. 8 represents the NWR according to the dosage of the polymers E and E′

FIG. 9 represents the NWR according to the dosage of the polymers F and F′

FIG. 10 represents the reversible equilibrium between a dormant and an active species

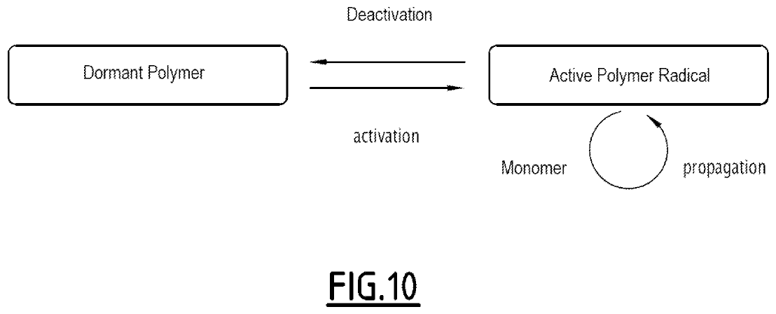

### EXAMPLES

Protocol for UL Viscosity Test:

500 mg of polymer are added to 490 ml of a solution of deionised water. After complete dissolution of the polymer, 29.25 grams of NaCl are added therein.

The viscosity is measured making use of a digital Brookfield Viscometer DVII+ with a rotational speed of 60 revolutions/minute at 25° C. (module UL).

Protocol for Flocculation Test:

First, the polymers are dissolved in deionised water in order to obtain aqueous solutions having a concentration of 0.4% by weight of polymer relative to the total weight of the solution. All of these solutions are mechanically agitated at 500 rpm until the polymers are completely dissolved and clear and homogeneous solutions are obtained. For each test, the appropriate volume of polymer solution is added to 200 g of MFT and then the complete mixture is mixed manually until such time as flocculation and optimum water release are observed.

The NWR represents the “Net Water Release”. It corresponds to the total amount of water recovered during the flocculation test minus the amount of water that gets added unduly during incorporation of the aqueous polymer solution in the suspension.

### Example 1: Synthesis of a Poly(Acrylamide-Co-Sodium Acrylate) Copolymer by the Uncontrolled Conventional Free Radical Polymerization Route (Counter-Example)

A 1.5 l reactor equipped with a mechanical agitator, a thermometer, and a nitrogen inlet is loaded with distilled water, acrylamide (AM) and acrylic acid (AA) based on the following composition:
Acrylamide: 70 mole %
Acrylic acid: 30 mole %

The mixture obtained is homogenized and then cooled, neutralized with sodium hydroxide to pH=7.6-7.7 and finally degassed under a stream of nitrogen. The polymerization is then initiated using a redox system (initiator). The resulting gel obtained after polymerization is subsequently ground and dried in a drying kiln so as to obtain a powder.

The UL viscosity of the reference polymer is 3.5 cps.

### Example 2: Synthesis of Poly(Acrylamide-Co-Sodium Acrylate) Copolymers by CRP According to the Invention (CRP 1)

A 1.5 l reactor equipped with a mechanical agitator, a thermometer, and a nitrogen inlet is loaded with distilled water, acrylamide (AM) and acrylic acid (AA) based on the following composition:
Acrylamide: 70 mole %
Acrylic acid: 30 mole %

The mixture obtained is homogenised and then cooled, neutralised with sodium hydroxide to pH=7.6-7.7 and finally degassed under a stream of nitrogen. The polymerisation is then initiated using a redox system (initiator), but in the presence of a radical polymerisation control agent having the formula (II). The resulting gel obtained after polymerisation is subsequently ground and dried in a drying kiln so as to obtain a powder. The UL viscosity of the polymer CRP 1 is 3.5 cps.

### Example 3: Synthesis of Poly (Acrylamide-Co-Sodium Acrylate) Copolymers by CRP According to the Invention (CRP 2)

The copolymer CRP 2 is synthesised under the same conditions as in Example 1, while replacing the sodium hydroxide with potassium hydroxide.

The UL viscosity of the polymer CRP 2 is 3.5 cps.

### Example 4: Flocculation of an MFT (29.2% by Weight of Dry Extract)

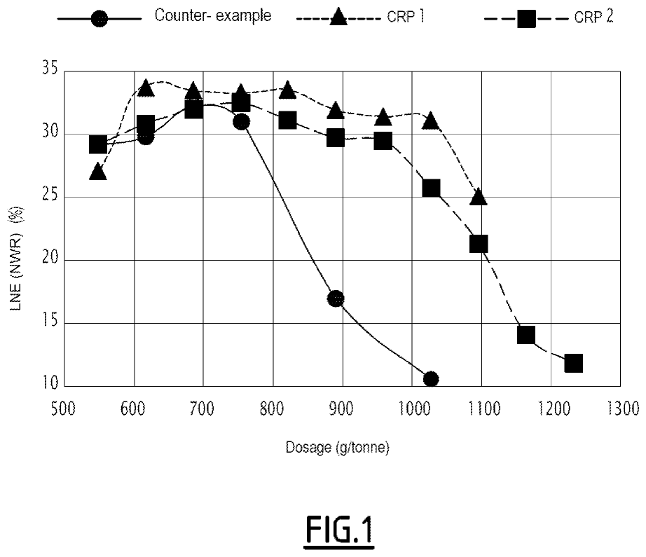

The flocculation tests are carried out on a suspension of mature fine tailings (MFT) derived from bituminous sands mining operations with a solids content of 29.2% by weight. The results obtained with the reference sample and the products CRP 1 and 2 are grouped together in FIG. 1. The results of these experiments show that the effect of overdosing of the two products CRP 1 and CRP 2 occurs at dosages that are much higher than that of the counter-example.

### Example 5: Flocculation of an MFT (33.2% by Weight of Dry Extract)

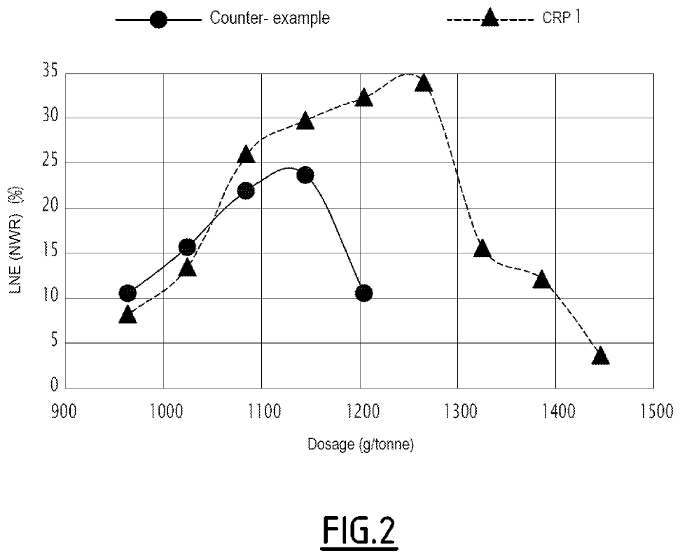

The flocculation tests are carried out on a suspension of mature fine tailings (MFT) derived from bituminous sands mining operations with a solids content of 33.2% by weight. The results obtained with the reference sample and the product CRP 1 are grouped together in FIG. 2. The results of these experiments show that the effect of overdosing of the product CRP 1 occurs at dosages that are higher than that of the reference product. In addition, the increase in the dosage of the polymer CRP 1 makes it possible to achieve LNE (NWR) values that are higher and never achieved by the reference product.

### Example 6: Flocculation of an MFT (31.7% by Weight of Dry Extract)

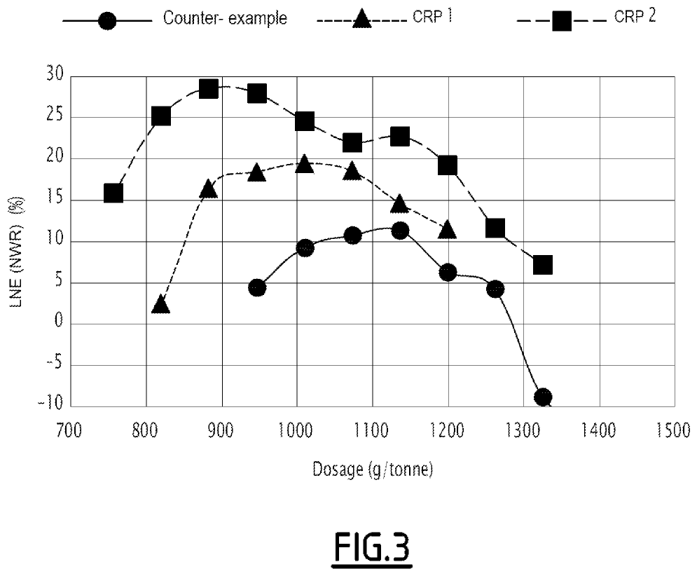

The flocculation tests are carried out on a suspension of mature fine tailings (MFT) derived from bituminous sands mining operations with a solids content of 31.7% by weight. The results obtained with the reference sample and the products CRP 1 and 2 are grouped together in FIG. 3. The results of these experiments show that the products CRP 1 and 2 have an optimal dosage that is much lower than that of the reference product and thus lead to LNE (NWR) values that are significantly higher and never achieved by the reference product.

### Example 7: Flocculation of an MFT (32.0% by Weight of Dry Extract)

Two series of six water-soluble polymers having UL viscosity of between 3.0 and 6.3 cps were prepared. One counter-example series wherein the water-soluble polymers are obtained according to the method described in Example 1 and one series referred to as “CRP” wherein the water-soluble polymers are obtained according to the method described in Example 2. The flocculation tests are carried out on a suspension of mature fine tailings (MFT) derived from bituminous sands mining operations with a solids content of 32.0% by weight. For each test, the results obtained are compared with a counter-example water-soluble polymer and a “CRP” water-soluble polymer having similar UL viscosities.

TABLE 1

| Counter- | | | |
|---|---|---|---|
| Example | | CRP | |
| Water- | UL | Water- | UL |
| Soluble | Viscosity | Soluble | Viscosity |
| Polymer | (cps) | Polymer | (cps) |
| A | 3 | A’ | 3 |
| B | 3.8 | B’ | 3.8 |
| C | 4.2 | C’ | 4.2 |
| D | 5.2 | D’ | 5.2 |
| E | 5.7 | E’ | 5.7 |
| F | 6.3 | F’ | 6.3 |

UL viscosity of the counter-example polymers and of the CRP polymers according to the invention

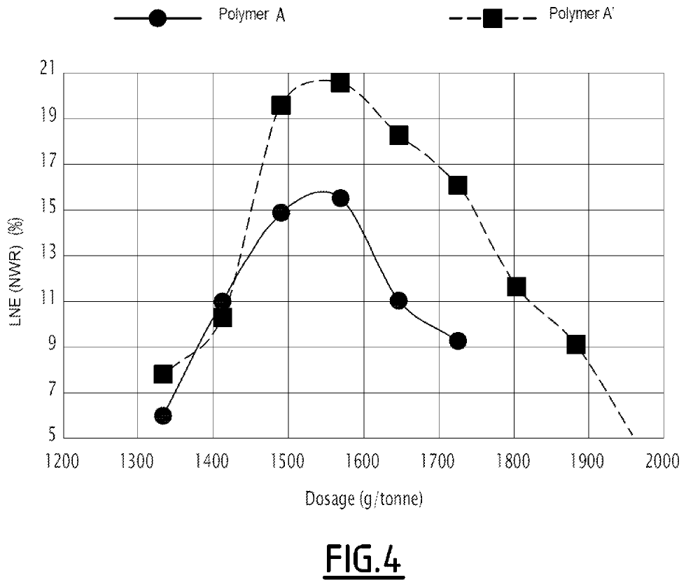

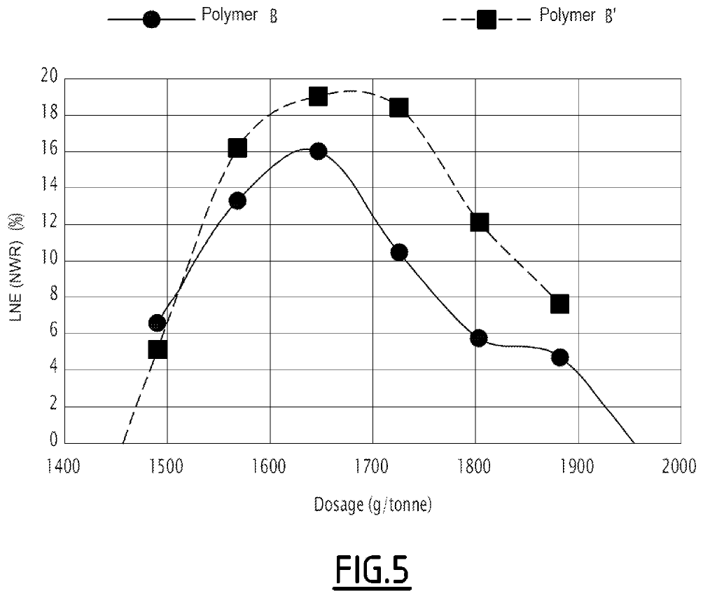

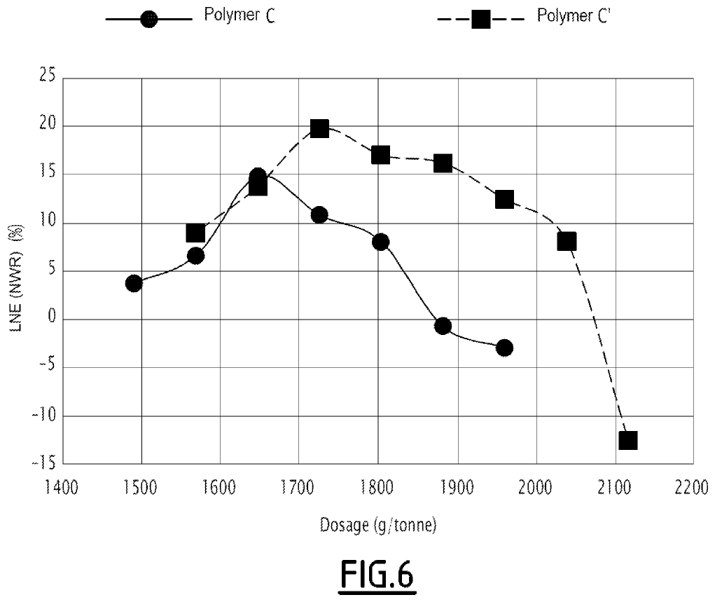

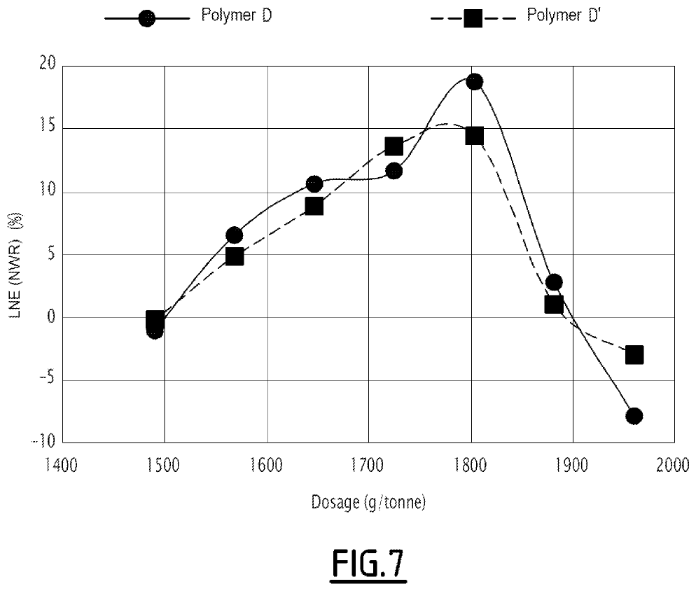

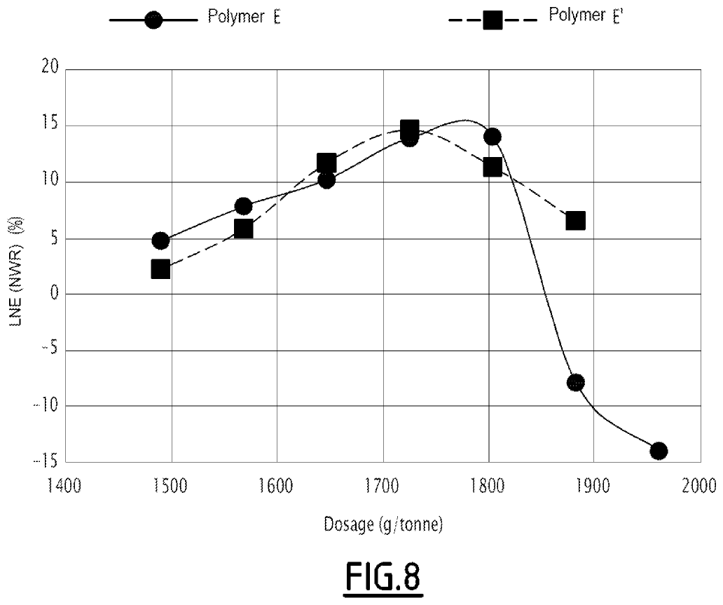

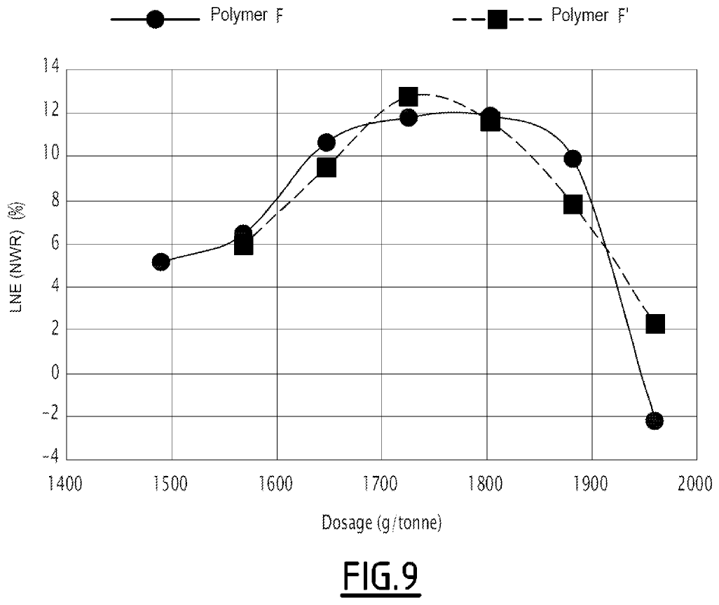

It is observed that, at equivalent UL, the CRP water-soluble polymers systematically lead to better performance than the reference water-soluble polymers (higher NWR values and wider dosage range) as long as the UL viscosity remains lower than or equal to 4.20 cps (FIGS. 4, 5 and 6). Above this value, there is almost no difference observed between the CRP water-soluble polymers and the reference water-soluble polymers (FIGS. 7, 8 and 9).

1. An effluent treatment method for treating an aqueous effluent that contains solid particles, the method including the addition to the effluent of at least one water-soluble polymer comprising at least one non-ionic monomer and at least one anionic monomer obtained by controlled radical polymerization, the said polymer having a UL viscosity of between 2 and 4.5 cps.

2. A method according to claim 1 wherein the controlled radical polymerization is a polymerization by reversible addition-fragmentation chain transfer, RAFT (Reversible Addition Fragmentation Chain Transfer Polymerization).

3. A method according to claim 2 wherein the controlled radical polymerization is carried out with a control agent having the formula (I): 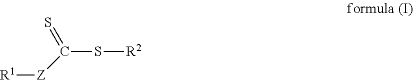
in which
Z═O, S or N;
R¹ and R², being identical or different, represent:
a group (i): alkyl, acyl, alkenyl or alkynyl, linear or crosslinked, optionally substituted; or
a carbon ring (ii), either saturated or unsaturated, optionally substituted or aromatic; or
a heterocycle (iii), either saturated or unsaturated, optionally substituted or aromatic, it being possible for these groups and rings (i), (ii), and (iii) to be substituted by substituted aromatic groups; or the groups: alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl; groups that are hydrophilic or ionic in nature such as the alkali salts of carboxylic acids, the alkali salts of sulfonic acid, polyalkylene oxide chains (polyoxyethylene POE, polyoxypropylene POP), cationic substituents (quaternary ammonium salts),
R representing an alkyl or aryl group.

4. A method according to claim 1, wherein the controlled radical polymerization is carried out with a control agent having the formula (I): 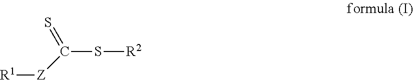
in which
Z═O, S or N;
R¹ and R², being identical or different, represent:
a group (i): linear or branched alkyl comprising from 1 to 20 carbons, preferably from 1 to 10 carbons, optionally substituted; linear or branched acyl comprising from 1 to 20 carbons, preferably from 1 to 10 carbons, optionally substituted; linear or branched alkenyl comprising from 2 to 20 carbons, preferably from 2 to 10 carbons, optionally substituted; or linear or branched alkynyl comprising from 2 to 20 carbons, preferably from 2 to 10 carbons, optionally substituted; or
a carbon ring (ii), either saturated or unsaturated, optionally substituted or aromatic, comprising from 4 to 7 carbons, preferentially from 5 to 6 carbons; or
a heterocycle (iii), either saturated or unsaturated, optionally substituted or aromatic, comprising 1, 2 or 3 heteroatoms selected from O, N or S, and from 3 to 6 carbons, preferentially from 4 to 5 carbons;
it being possible for these groups and rings (i), (ii), and (iii) to be substituted by substituted aromatic groups; or the groups: alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl; groups that are hydrophilic or ionic in nature such as the alkali salts of carboxylic acids, the alkali salts of sulfonic acid, polyalkylene oxide chains (polyoxyethylene POE, polyoxypropylene POP), cationic substituents (quaternary ammonium salts);
R representing a linear or branched alkyl group comprising from 1 to 20 carbons, preferably from 1 to 10 carbons, or aryl comprising from 6 to 10 carbon atoms.

5. A method according to claim 4 wherein in formula (I) Z═O.

6. A method according to claim 5 wherein in formula (I)
R¹ and R², being identical or different, represent a group (i): linear or branched alkyl comprising from 1 to 20 carbons, preferably from 1 to 10 carbons; linear or branched acyl comprising from 1 to 20 carbons, preferably from 1 to 10 carbons; linear or branched alkenyl comprising from 2 to 20 carbons, preferably from 2 to 10 carbons; or linear or branched alkynyl comprising from 2 to 20 carbons, preferably from 2 to 10 carbons; these groups being optionally substituted by one or more substituted aromatic groups comprising from 4 to 7 carbons; or the groups: alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl; groups that are hydrophilic or ionic in nature such as the alkali salts of carboxylic acids, the alkali salts of sulfonic acid, polyalkylene oxide chains (polyoxyethylene POE, polyoxypropylene POP), cationic substituents (quaternary ammonium salts);
R representing a group: linear or branched alkyl comprising from 1 to 20 carbons, preferably from 1 to 10 carbons; or aryl comprising from 6 to 10 carbon atoms.

7. A method according to claim 1, wherein the controlled radical polymerization is carried out with a control agent having the formula (II):

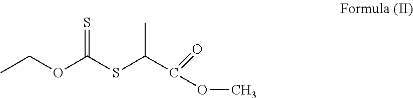

8. A method according to claim 1, wherein the effluent is:
A mining operation effluent, deriving from coal mines, diamond mines, phosphate mines, metal mines such as aluminum, platinum, iron, gold, copper, silver; or
An effluent from bituminous sands or oil sands mining operations; or
An effluent that contains from 5 to 70% by mass, preferably from 20 to 50% by mass, more preferentially from 30 to 40% by mass, of solid particles; or
An effluent that comprises sand, clay and water; or
An effluent that comprises sand, clay, water and residual bitumen; or
An effluent that comprises fresh tailings; or
An effluent that comprises fine tailings; or
An effluent that comprises fresh fine tailings (FFT or RFF for ‘résidus fins frais’); or
An effluent that comprises mature fine tailings (MFT or RFM for ‘rësidus fins mûrs’).

9. A method according to claim 1, wherein the said polymer has a UL viscosity of between 2.5 and 4.2 cps.

10. A method according to claim 1, wherein the non-ionic monomer is selected from acrylamide, methacrylamide; N-isopropylacrylamide; N,N-dimethylacrylamide; N,N diethylacrylamide; N-methylolacrylamide; N-vinylformamide; N-vinyl acetamide; N-vinylpyridine; N-vinylpyrrolidone; acryloyl morpholine (ACMO), glycidyl methacrylate, glyceryl methacrylate, and diacetone acrylamide.

11. A method according to claim 1, wherein the anionic monomer is selected from among acrylic acid; methacrylic acid; itaconic acid; crotonic acid; maleic acid; fumaric acid; 2-acrylamido-2-methylpropane sulfonic acid; vinyl sulfonic acid; vinylphosphonic acid; allylsulfonic acid; allylphosphonic acid; styrene sulfonic acid, the said anionic monomer being non-salified, partially or totally salified, and the salts of 3-sulfopropyl methacrylate.

12. A method according to claim 1, wherein the polymer is obtained from acrylamide and acrylic acid.

13. (canceled)

14. A composition comprising an aqueous effluent that contains solid particles, at least one water-soluble polymer comprising at least one non-ionic monomer and at least one anionic monomer obtained by controlled radical polymerization, the said polymer having a UL viscosity of between 2 and 4.5 cps.
